(19) United States
(12) Patent Application Publication
(10) Pub. No.: US 2006/0089735 A1
(43) Pub. Date: Apr. 27, 2006

(54) Method and apparatus for configuring the audio outputs of an electronic device

(76) Inventor: Lee W. Atkinson, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/971,746

(22) Filed: Oct. 21, 2004

(51) Int. Cl. G06F 17/00; H04B 15/00

(52) U.S. Cl. 700/94; 381/94.5

(57) ABSTRACT

An electronic device automatically detects whether an SPDIF receiver or an HDMI display is electrically connected with the electronic device and favors an external digital audio connection, when available. In some embodiments, an analog audio output is automatically muted, when a digital audio connection is detected. In other embodiments, the electronic device automatically configures its digital and analog audio outputs in accordance with a set of predetermined user preferences, when a digital audio connection is detected.

### FIELD OF THE INVENTION

The present invention relates generally to electronic devices and more specifically to techniques for automatically configuring the audio outputs of such devices.

### BACKGROUND OF THE INVENTION

Some electronic devices have both digital and analog audio outputs. Often, an analog audio output drives a set of internal (built-in) speakers or is fed to a “line-out” jack. It is common practice to disable (mute) the internal speakers automatically when an external device or a set of external speakers is connected with an analog output of the electronic device (e.g., a headphones or line-out jack).

In connecting an electronic device such as a notebook computer with, e.g., a home theater system, most users prefer a digital audio connection with the home theater system rather than the device's built-in speakers. Examples of digital audio standards include the Sony-Philips Digital Interface Format (SPDIF) and the High-Definition Multimedia Interface (HDMI). Unfortunately, current electronic devices require the user to disable the analog audio output (internal speakers or line-out jack) manually when a digital-audio-capable device is connected.

It is thus apparent that there is a need in the art for an improved method and apparatus for configuring the audio outputs of an electronic device.

### SUMMARY OF THE INVENTION

A method for configuring a set of audio outputs of an electronic device is provided. The method automatically detects a digital audio connection and may respond to the detected digital audio connection in several different ways, depending on the application, including automatically muting an analog audio output of the electronic device or consulting a set of predetermined user preferences that specify how the audio outputs are to be configured. An apparatus for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of an electronic device connected with an SPDIF receiver and an HDMI display in accordance with an illustrative embodiment of the invention.

FIG. 2 is a functional block diagram of an electronic device in accordance with an illustrative embodiment of the invention.

FIG. 3 is a more detailed diagram of an electronic device connected with an SPDIF receiver and an HDMI display in accordance with an illustrative embodiment of the invention.

FIG. 4 is a simplified block diagram of an HDMI connection in accordance with an illustrative embodiment of the invention.

FIG. 5 is a more detailed diagram of an electronic device connected with an SPDIF receiver and an HDMI display in accordance with another illustrative embodiment of the invention.

FIG. 6 is a flowchart of a method for configuring a set of audio outputs of an electronic device in accordance with an illustrative embodiment of the invention.

FIG. 7 is a flowchart of a method for configuring a set of audio outputs of an electronic device in accordance with another illustrative embodiment of the invention.

FIG. 8 is a flowchart of a method for configuring a set of audio outputs of an electronic device in accordance with yet another illustrative embodiment of the invention

### DETAILED DESCRIPTION OF THE INVENTION

An electronic device having both analog and digital audio outputs can be made more convenient to use by including in the device the capability of automatically disabling one or more analog audio outputs (e.g., internal speakers or line-out jack) when a digital audio connection with the device is detected. In such a situation, one or more digital audio outputs of the electronic device may also be enabled automatically. Flexibility may be increased by consulting a set of predetermined user preferences when a digital audio connection is detected. The audio outputs of the electronic device (analog and digital) may be configured (e.g., enabled or disabled) in accordance with the set of predetermined user preferences. If the digital audio connection comprises a connection to multiple external digital devices, a particular digital audio output of the electronic device may be preferred over the others. In some situations, the absence of a connection between the electronic device and a particular external digital device (e.g., an SPDIF receiver) allows the electronic device to save power by disabling the corresponding digital audio output of the electronic device.

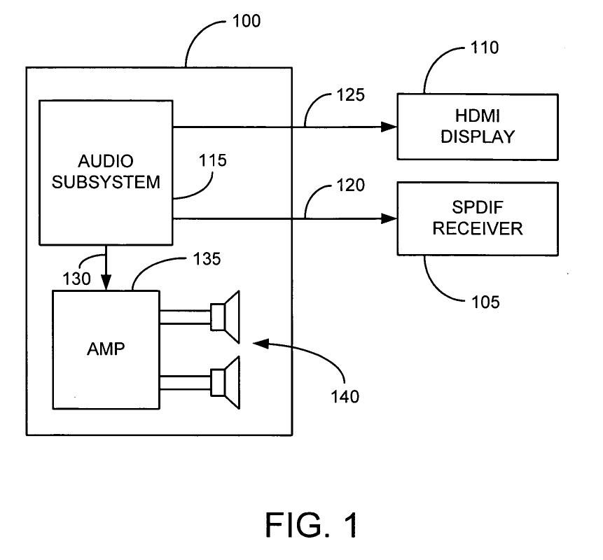

FIG. 1 is a block diagram of an electronic device 100 connected with a Sony-Philips Digital Interface Format (SPDIF) receiver 105 and a High-Definition Multimedia Interface (HDMI) display 110 in accordance with an illustrative embodiment of the invention. Throughout this detailed description, “digital audio connection” means an electrical connection between electronic device 100 and (1) SPDIF receiver 105, (2) HDMI display 110, or (3) both. The SPDIF and HDMI digital audio formats are well known to those skilled in the art, and their specifications are readily available to hardware and software developers. The SPDIF format transmits digital audio in a serial, multiplexed fashion. The HDMI format supports both video and digital audio and is widely used in Digital Versatile Disc (DVD) players and similar devices. In FIG. 1, electronic device 100 includes audio subsystem 115, which has SPDIF audio output 120 and HDMI audio output 125. SPDIF audio output 120 is connected with SPDIF receiver 105. HDMI audio output 125 is connected with HDMI display 110. HDMI display 110 may receive both video and digital audio data from electronic device 100. However, only the digital audio portion (HDMI audio output 125) is shown in the simplified block diagram of FIG. 1. Audio subsystem 115 also has analog audio output 130, which is fed to amplifier 135. Amplifier 135 drives internal speakers 140.

Electronic device 100 may be any electronic device that includes at least one analog audio output and at least one digital audio output (e.g., SPDIF or HDMI). Examples of such electronic devices 100 include, but are not limited to, desktop computers, notebook computers, personal digital assistants (PDAs), and portable DVD players. In FIG. 1, electronic device 100 is shown connected with both SPDIF receiver 105 and HDMI display 110. In some embodiments, only one of the two digital connections may be present. Audio subsystem 115 may include an audio codec and other components that are not shown in FIG. 1.

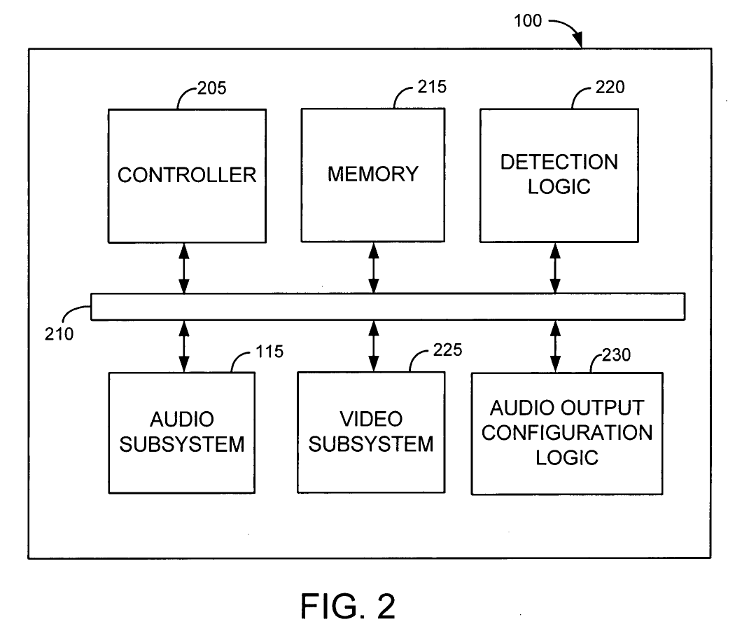

FIG. 2 is a functional block diagram of electronic device 100 in accordance with an illustrative embodiment of the invention. Controller 205 (e.g., a microprocessor or microcontoller) communicates over data bus 210 with memory 215, detection logic 220, audio subsystem 115, optional video subsystem 225, and audio output configuration logic 230. Memory 215 may include random access memory (RAM), read-only memory (ROM), or both. Video subsystem 225 may drive one or more displays connected with or built into electronic device 100 (not shown in FIG. 2).

Detection logic 220 and audio output configuration logic 230 are purely functional in nature as they are depicted in FIG. 2 and may be implemented in a wide variety of ways, all of which are considered to be within the scope of the invention as claimed. As with other aspects of electronic device 100, these functions may be implemented in software, hardware, firmware, or any combination thereof. Detection logic 220 may automatically determine whether SPDIF receiver 105, HDMI display 110, or both is electrically connected with electronic device 100. In some embodiments, detection logic 220 may comprise hardware (e.g., combinational logic) that operates separately from controller 205. In other embodiments, detection logic 220 may generate an interrupt that informs an application executed by controller 205 that a digital audio connection is present. Audio output configuration logic 230 may automatically disable some audio outputs of electronic device 100 (e.g., internal speakers) and enable others, when detection logic 220 has determined that a digital audio connection is present. In some embodiments, audio output configuration logic 230 may comprise hardware that directly mutes or enables audio outputs without the involvement of controller 205. In other embodiments, audio output configuration logic 230 may comprise stored program code that is executed by controller 205. For example, audio output configuration logic 230 may configure the audio outputs (120, 125, and 130) of electronic device 100 in response to an interrupt from detection logic 220. Illustrative implementations of detection logic 220 and audio output configuration logic 230 are described in subsequent portions of this detailed description.

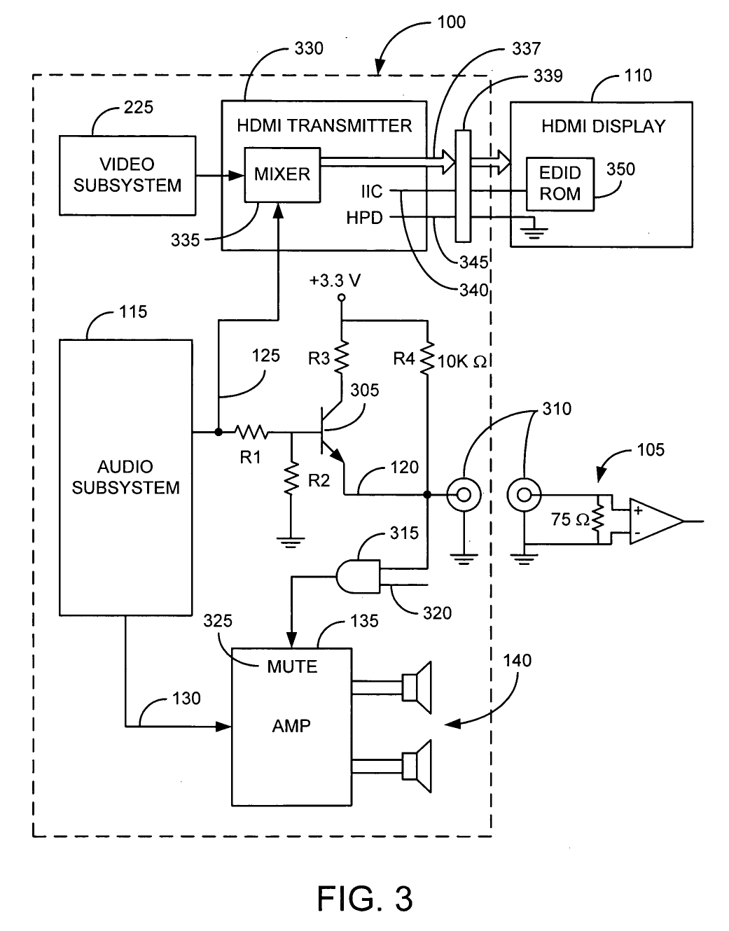

FIG. 3 is a more detailed diagram of electronic device 100 connected with SPDIF receiver 105 and HDMI display 110 in accordance with an illustrative embodiment of the invention. In the illustrative implementation of FIG. 3, SPDIF audio output 120 is taken from NPN transistor 305. Resistor R4 biases the output of transistor 305 to the supply voltage (e.g., 3.3 V) when no cable is connected between RCA jacks 310 of electronic device 100 and SPDIF receiver 105, respectively. When such a cable is connected, the 75-ohm load of SPDIF receiver 105 causes SPDIF audio output 120 to drop to a lower maximum level (e.g., 0.5 V). This drop in level due to the 75-ohm load may be sensed by AND gate 315, producing a “low” (logic “0”) at its output. Additionally, an HDMI detect signal 320 may also be fed to AND gate 315. HDMI detect signal 320 may be asserted low when HDMI display 110 is connected with electronic device 100. Some illustrative ways of implementing HDMI detect signal 320 will be explained below. As shown in FIG. 3, the presence of a digital audio connection will cause AND gate 315 to output a low voltage level. The output of AND gate 315 may be connected with mute input 325 of amplifier 135. When mute input 325 is low, amplifier 135 does not output its analog signal to internal speakers 140 (i.e., internal speakers 140 are disabled).

In the embodiment of FIG. 3, HDMI audio output 125 is fed to HDMI transmitter 330 from audio subsystem 115. In this configuration, SPDIF audio output 120 and HDMI audio output 125 are two branches of a common SPDIF audio output (i.e., they share a common audio engine). In other embodiments, HDMI transmitter 330 may receive digital audio from a source that is separate from SPDIF audio output 120. Mixer 335 of HDMI transmitter 330 may combine the SPDIF audio output of audio subsystem 115 (HDMI audio output 125) with the output of video subsystem 225 to form Transition Minimized Differential Signaling (TMDS) data stream 337. HDMI transmitter also includes Inter-Integrated Circuit Standard (IIC) bus 340 and Hot Plug Detect (HPD) signal 345. TMDS data stream 337, IIC bus 340, and HPD signal 345 may be connected with HDMI display 110 via HDMI interface 339 of electronic device 100. HDMI display 110 includes Extended Display Identification Data (EDID) ROM 350, which contains, among other things, details about the audio capabilities of HDMI display 110.

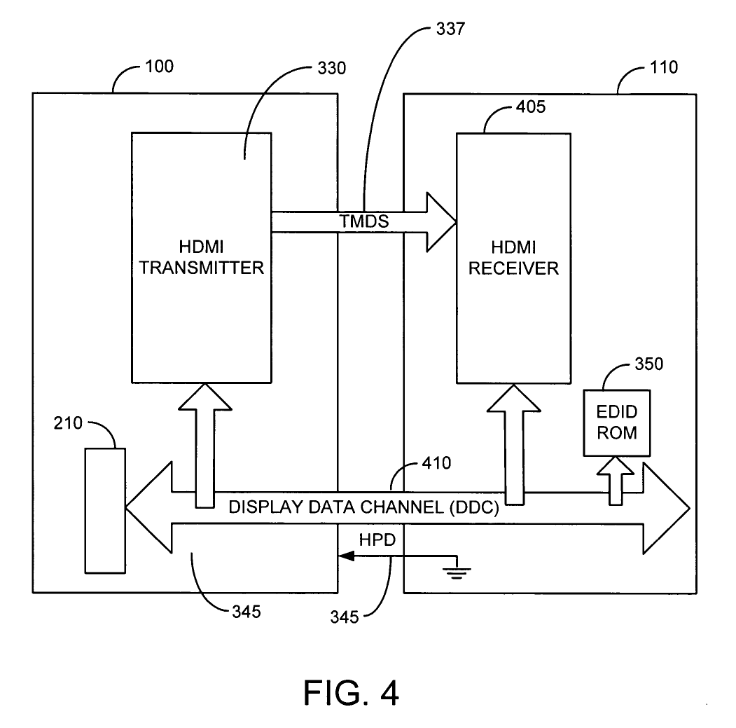

At least two approaches may be used to detect a connection between electronic device 100 and HDMI display 110. In a first approach, HPD signal 345 may be used. When electronic device 100 is connected with HDMI display 100 via HDMI interface 339, HPD signal 345 is pulled down to ground potential. HPD signal 345 may therefore be used directly as HDMI detect signal 320. Alternatively, software or firmware executed by controller 205 may ascertain the audio capabilities of HDMI display 110 by reading EDID ROM 350. The software or firmware, in conjunction with the appropriate hardware, may generate HDMI detect signal 320 accordingly. How controller 205 may read EDID ROM 350 is shown in FIG. 4.

FIG. 4 is a simplified block diagram of an HDMI connection in accordance with an illustrative embodiment of the invention. In FIG. 4, HDMI transmitter 330 of electronic device 100 is connected with HDMI receiver 405 via both TMDS data stream 337 and Display Data Channel (DDC) 410. DDC 410 is also accessible to controller 205 over data bus 210, allowing controller 205 to read EDID ROM 350 to ascertain the audio capabilities of HDMI display 110. For clarity, other details of an HDMI connection that are well known to those skilled in the art have been omitted from FIG. 4.

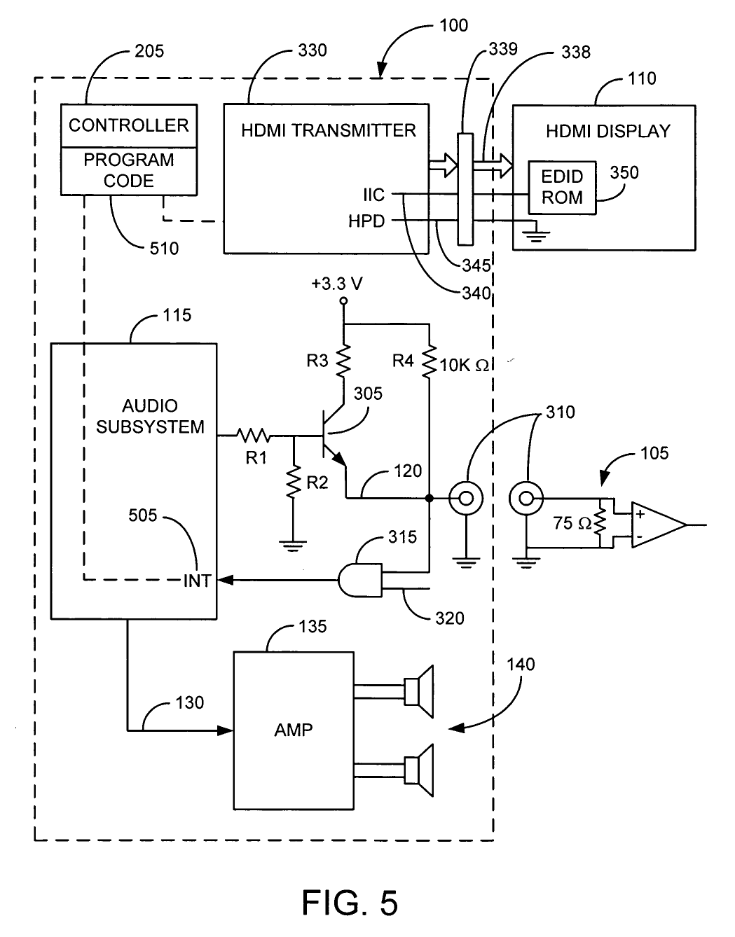

FIG. 5 is a more detailed diagram of electronic device 100 connected with SPDIF receiver 105 and HDMI display 110 in accordance with another illustrative embodiment of the invention. In this embodiment, the output of AND gate 315 is fed to an interrupt input of audio subsystem 115. Audio subsystem 115 may generate an interrupt 505 when the output of AND gate 315 is low to signal program code 510 (e.g., an application program) that SPDIF receiver 105, HDMI display 110, or both is electrically connected with electronic device 100. Audio output configuration logic 230, which may be an aspect of program code 510, may respond to interrupt 505 by consulting a set of predetermined user preferences (not shown in FIG. 5). The set of predetermined user preferences may specify which audio outputs of electronic device 100 are to be enabled and which are to be disabled when a digital audio connection is present. Audio output configuration logic 230 may then configure (enable or disable) each audio output of electronic device 100 in accordance with the set of predetermined user preferences.

In FIGS. 3 and 5, detection logic 220 comprises the signals that are input to AND gate 315. In the embodiment of FIG. 3, audio output configuration logic 230 comprises the output of AND gate 315 and its connection with mute input 325 of amplifier 135. Audio output configuration logic 230 may also include program code or other logic that enables one or more digital audio outputs such as SPDIF audio output 120 and HDMI audio output 125, when the corresponding external device is connected with electronic device 100. In FIG. 5, audio output configuration logic 230 comprises controller 205 and program code 510, which communicates with audio subsystem 115 and HDMI transmitter 330 to enable or disable SPDIF audio output 120, HDMI audio output 125, and analog audio output 130 in accordance with the set of predetermined user preferences. For clarity, not all details of the connections among controller 205, audio subsystem 115, and HDMI transmitter 330 have been shown in FIG. 5.

In variations of the illustrative embodiments shown in FIGS. 3 and 5, detection logic 220 may separately determine whether SPDIF receiver 105 or HDMI display 110 is electrically connected with electronic device 100 instead of logically combining the detection signals as shown in FIGS. 3 and 5. Detecting the external device connections separately allows different actions to be taken depending on the presence or absence of a particular external digital device. For example, the portion of audio subsystem 115 that produces SPDIF audio output 120 (e.g., the associated logic in the audio codec) may be disabled when no SPDIF receiver 105 is electrically connected with electronic device 100. Disabling SPDIF audio output 120 when SPDIF receiver 105 is not connected saves power, which can be important in a portable device such as a PDA.

In another variation, detection logic 220 may determine whether both SPDIF receiver 105 and HDMI display 110 are electrically connected with electronic device 100 simultaneously. For example, the same signals input to AND gate 315 in FIGS. 3 and 5 may be fed to an OR gate to produce an output that is low when both inputs are low. If both external devices are connected with electronic device 100, it may be advantageous in some applications to enable one digital audio output and to disable the other. That is, SPDIF audio output 120 may be preferable over HDMI audio output 125 or vice versa. Enabling or disabling a particular digital audio output may be accomplished, for example, under software or firmware control via controller 205, as explained above.

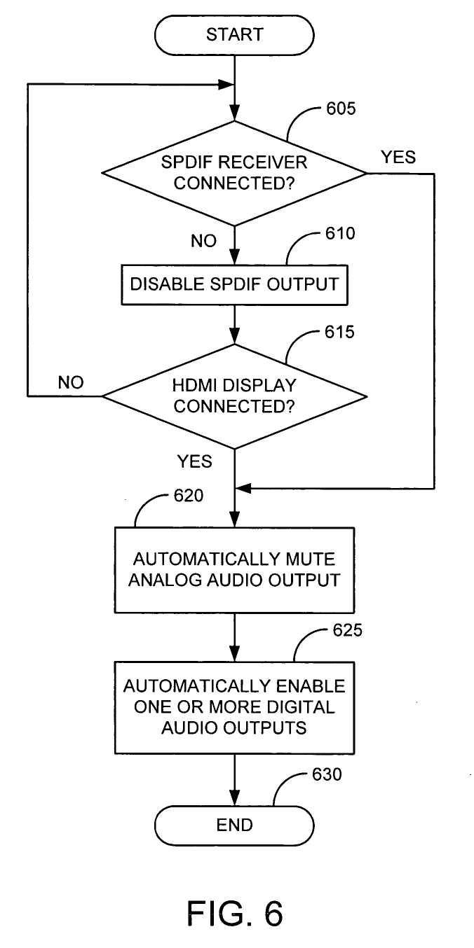

FIG. 6 is a flowchart of a method for configuring a set of audio outputs of electronic device 100 in accordance with an illustrative embodiment of the invention. At 605, detection logic 220 determines whether SPDIF receiver 105 is electrically connected with electronic device 100. If not, audio output configuration logic 230 may optionally disable SPDIF audio output 120 at 610, as indicated in FIG. 6. As explained above, the step at 610 requires being able to detect connections with SPDIF receiver 105 and HDMI display 110 separately. If SPDIF receiver 105 is connected at 605, audio output configuration logic 230 may mute analog audio output 130 at 620. If HDMI display 110 is electrically connected with electronic device 100 at 615, the process again proceeds to 620, where analog audio output 130 may be muted. Optionally, audio output configuration logic 230 may, at 625, enable one or more digital audio outputs such as SPDIF audio output 120 and HDMI audio output 125. The process may then terminate at 630.

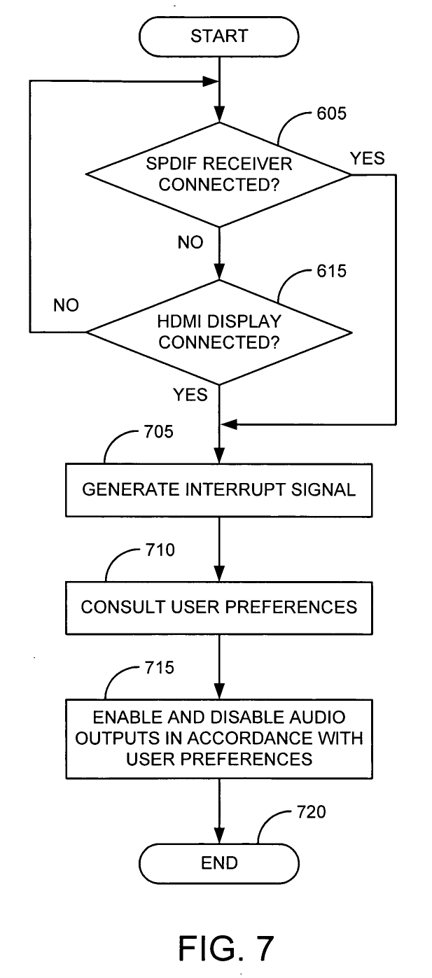

FIG. 7 is a flowchart of a method for configuring a set of audio outputs of electronic device 100 in accordance with another illustrative embodiment of the invention. The top portion of FIG. 7 is similar to FIG. 6. If SPDIF receiver 105, HDMI display 110, or both is electrically connected with electronic device 100 at 605 and 615, detection logic 220 may generate interrupt signal 505 at 705. Audio output configuration logic 230 may, at 710, consult a set of predetermined user preferences and enable or disable audio outputs (e.g., 120, 125, and 130) in accordance with the set of predetermined user preferences at 715. The process may terminate at 720.

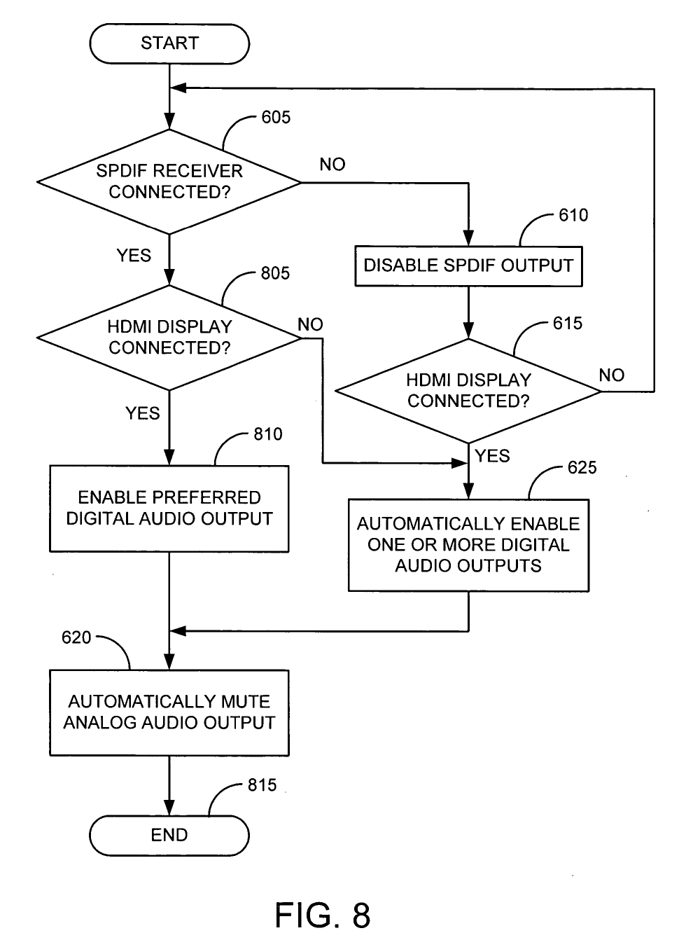

FIG. 8 is a flowchart of a method for configuring a set of audio outputs of electronic device 100 in accordance with yet another illustrative embodiment of the invention. If electronic device 100 is electrically connected with SPDIF receiver 105 at 605 and simultaneously with HDMI display 110 at 805, the preferred digital audio output (SPDIF audio output 120 or HDMI audio output 125) may be enabled at 810. At 620, analog audio output 130 may be automatically muted. If electronic device 100 is not electrically connected with SPDIF receiver 105 at 605, SPDIF audio output 120 may optionally be disabled at 610. If, however, electronic device 100 is electrically connected with HDMI display 110 at 615, one or more digital audio outputs (e.g., HDMI audio output 125) may be enabled automatically at 625. The process terminates at 815.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for configuring a set of audio outputs of an electronic device, comprising:
determining whether at least one of an SPDIF receiver and an HDMI display is electrically connected with the electronic device; and
muting an analog audio output automatically, when at least one of an SPDIF receiver and an HDMI display is electrically connected with the electronic device.

2. The method of claim 1, further comprising:
enabling at least one of an SPDIF audio output and an HDMI audio output automatically, when at least one of an SPDIF receiver and an HDMI display is electrically connected with the electronic device.

3. The method of claim 1, further comprising:
determining whether an SPDIF receiver is electrically connected with the electronic device; and
disabling an SPDIF audio output automatically, when no SPDIF receiver is electrically connected with the electronic device.

4. The method of claim 1, further comprising:
determining whether both an SPDIF receiver and an HDMI display are electrically connected with the electronic device; and
enabling an SPDIF audio output and disabling an HDMI audio output automatically, when both an SPDIF receiver and an HDMI display are electrically connected with the electronic device.

5. The method of claim 1, further comprising:
determining whether both an SPDIF receiver and an HDMI display are electrically connected with the electronic device; and
enabling an HDMI audio output and disabling an SPDIF audio output automatically, when both an SPDIF receiver and an HDMI display are electrically connected with the electronic device.

6. The method of claim 1, wherein the analog audio output drives a set of internal speakers, the set of internal speakers being disabled when the analog audio output is muted.

7. The method of claim 1, wherein the analog audio output comprises a line-level output jack.

8. The method of claim 1, wherein determining whether at least one of an SPDIF receiver and an HDMI display is electrically connected with the electronic device comprises sensing a predetermined load on an SPDIF audio output of the electronic device, when an SPDIF receiver is electrically connected with the electronic device.

9. The method of claim 1, wherein determining whether at least one of an SPDIF receiver and an HDMI display is electrically connected with the electronic device comprises sensing a predetermined logic state of a signal in an HDMI interface of the electronic device, when an HDMI display is electrically connected with the electronic device.

10. The method of claim 1, wherein determining whether at least one of an SPDIF receiver and an HDMI display is electrically connected with the electronic device comprises reading a read-only memory of the HDMI display, when an HDMI display is electrically connected with the electronic device.

11. The method of claim 1, wherein the electronic device is one of a desktop computer, a notebook computer, a PDA, and a portable DVD player.

12. A method for configuring a set of audio outputs of an electronic device, comprising:
determining whether at least one of an SPDIF receiver and an HDMI display is electrically connected with the electronic device;
generating an interrupt signal, when at least one of an SPDIF receiver and an HDMI display is electrically connected with the electronic device;
consulting a set of predetermined user preferences in response to the interrupt signal; and
enabling a first subset of audio outputs in the set of audio outputs and disabling a second subset of audio outputs in the set of audio outputs in accordance with the set of predetermined user preferences.

13. The method of claim 12, wherein determining whether at least one of an SPDIF receiver and an HDMI display is electrically connected with the electronic device comprises sensing a predetermined load on an SPDIF audio output of the electronic device, when an SPDIF receiver is electrically connected with the electronic device.

14. The method of claim 12, wherein determining whether at least one of an SPDIF receiver and an HDMI display is electrically connected with the electronic device comprises sensing a predetermined logic state of a signal in an HDMI interface of the electronic device, when an HDMI display is electrically connected with the electronic device.

15. The method of claim 12, wherein determining whether at least one of an SPDIF receiver and an HDMI display is electrically connected with the electronic device comprises reading a read-only memory of the HDMI display, when an HDMI display is electrically connected with the electronic device.

16. The method of claim 12, wherein the electronic device is one of a desktop computer, a notebook computer, a PDA, and a portable DVD player.

17. An electronic device, comprising:
an audio subsystem having a set of audio outputs;
detection logic configured to determine whether at least one of an SPDIF receiver and an HDMI display is electrically connected with the electronic device; and
audio output configuration logic configured to disable automatically an analog audio output, when the detection logic determines that the electronic device is electrically connected with at least one of an SPDIF receiver and an HDMI display.

18. The electronic device of claim 17, wherein the analog audio output drives a set of internal speakers, the set of internal speakers being disabled when the analog audio output is disabled.

19. The electronic device of claim 17, wherein the analog audio output comprises a line-level output jack.

20. The electronic device of claim 17, wherein the audio output configuration logic is further configured to enable at least one of an SPDIF audio output and an HDMI audio output automatically, when the detection logic determines that the electronic device is electrically connected with at least one of an SPDIF receiver and an HDMI display.

21. The electronic device of claim 17, wherein the detection logic is configured to determine whether an SPDIF receiver is electrically connected with the electronic device and the audio output configuration logic is configured to disable an SPDIF audio output automatically, when no SPDIF receiver is electrically connected with the electronic device.

22. The electronic device of claim 17, wherein the detection logic is configured to determine whether both an SPDIF receiver and an HDMI display are electrically connected with the electronic device and the audio output configuration logic is configured to enable an SPDIF audio output and disable an HDMI audio output automatically, when both an SPDIF receiver and an HDMI display are electrically connected with the electronic device.

23. The electronic device of claim 17, wherein the detection logic is configured to determine whether both an SPDIF receiver and an HDMI display are electrically connected with the electronic device and the audio output configuration logic is configured to enable an HDMI audio output and disable an SPDIF audio output automatically, when both an SPDIF receiver and an HDMI display are electrically connected with the electronic device.

24. An electronic device, comprising:
an audio subsystem having a set of audio outputs;
detection logic that determines whether at least one of an SPDIF receiver and an HDMI display is electrically connected with the electronic device, the detection logic being configured to generate an interrupt signal when at least one of an SPDIF receiver and an HDMI display is electrically connected with the electronic device; and
audio output configuration logic that consults a set of predetermined user preferences in response to the interrupt signal, the audio output configuration logic being configured to enable a first subset of audio outputs in the set of audio outputs and to disable a second subset of audio outputs in the set of audio outputs in accordance with the set of predetermined user preferences.

25. The electronic device of claim 24, wherein the detection logic comprises a circuit that outputs a first predetermined logic state, when no SPDIF receiver is electrically connected with the electronic device, and outputs a second predetermined logic state distinct from the first predetermined logic state, when an SPDIF receiver is electrically connected with the electronic device.

26. The electronic device of claim 24, wherein the detection logic comprises a signal in an HDMI interface of the electronic device, the signal being at a first predetermined logic state, when no HDMI display is electrically connected with the electronic device, the signal being at a second predetermined logic state distinct from the first predetermined logic state, when an HDMI display is electrically connected with the electronic device.

27. The electronic device of claim 24, wherein the detection logic is configured to read a read-only memory of the HDMI display to ascertain audio capabilities of the HDMI display, when an HDMI display is electrically connected with the electronic device.

28. The electronic device of claim 24, wherein the electronic device is one of a desktop computer, a notebook computer, a PDA, and a portable DVD player.

29. An electronic device, comprising:
means for outputting audio, the means for outputting audio having multiple audio outputs;
means for determining whether at least one of an SPDIF receiver and an HDMI display is electrically connected with the electronic device; and
means for automatically disabling an analog audio output, when the means for determining whether the electronic device is electrically connected with at least one of an SPDIF receiver and an HDMI display determines that the electronic device is electrically connected with at least one of an SPDIF receiver and an HDMI display.

30. An electronic device, comprising:
means for outputting audio, the means for outputting audio having multiple audio outputs;
means for determining whether at least one of an SPDIF receiver and an HDMI display is electrically connected with the electronic device, the means for determining whether at least one of an SPDIF receiver and an HDMI display is electrically connected with the electronic device being configured to generate an interrupt signal when at least one of an SPDIF receiver and an HDMI display is electrically connected with the electronic device;
means for consulting a set of predetermined user preferences in response to the interrupt signal; and
means for enabling a first subset of audio outputs in the set of audio outputs and disabling a second subset of audio outputs in the set of audio outputs in accordance with the set of predetermined user preferences.
